(19) United States
(12) Patent Application Publication
(10) Pub. No.: US 2002/0107766 A1
(43) Pub. Date: Aug. 8, 2002

(54) Financial instrument certificate purchasing system

(76) Inventor: Antoine Sioufi, Ottawa (CA)

Correspondence Address: McFadden, Fincham, Suite 606, 225 Metcalfe Street, Ottawa, ON, K2P 1P9, CA

(21) Appl. No.: 09/773,577

(22) Filed: Feb. 2, 2001

(51) Int. Cl. G06F 17/60

(52) U.S. Cl. 705/35

(57) ABSTRACT

A system for issuing, transferring and redeeming financial certificates which are representative of underlying publicly-traded property consists of means for carrying out a series of steps which permit an individual to gift a third party with a certificate which represents a company's security or other financial instrument, while not itself consisting of the financial instrument. The system consists of a means for establishing a communication link between a customer and a supplier of the certificates, providing a menu to the customer to permit the customer to select one or more corporate securities or other financial instruments, establishing a communication link between a supplier and a provider of price information relating to the securities, and permitting the customer to select the desired securities for gifting to a third party. The system also includes means for receiving personal information from the customer such as payment information, as well as the personal information of the certificate recipient. Finally, means are included for printing or otherwise creating the certificate, and conveying the certificate to the ultimate recipient. The holder of the certificate may then redeem the certificate at his option, the redemption price being set by the current market price for the underlying security.

### FIELD OF THE INVENTION

This invention relates generally to transactions involving financial instruments such as company stock. More specifically, it relates to a system for facilitating transactions involving printed share certificates and other printed financial instruments, particularly those in which the certificate is transferred to a third party.

### BACKGROUND OF THE INVENTION

Equity transactions and other like transactions in financial instruments are traditionally conducted through a broker or other licensed agent. In most jurisdictions such a transaction involves a fairly complex brokerage structure and a regulatory regime designed to ensure that shareholders properly acquire the rights and benefits associated with share ownership. Share purchase does not usually involve the transfer of a physical share certificate, but rather only data entries in the computerized records of the broker and the share issuing corporation. In most jurisdictions shareholders are entitled to receive a printed share certificate; however, this typically entails an additional expense to the shareholder. This optional right is rarely exercised and thus typically does not pose a problem when corporate equities are used only as an investment vehicle. For most such purchasers, the printed share certificate is unnecessary and even unwanted.

It is increasingly popular to give individual shares or small numbers of shares as a gift. In these situations, it is often desirable to provide the printed share certificate. Also desirable to such a recipient of share certificates (e.g. a person who has been gifted a small number of certificates) is the right to participate in any increase of market value of the shares, as well as participation in any dividends, stock splits, or other financial benefits which accompany equity ownership. Typically, an individual holder of a low number of shares is not particularly interested in voting rights, receipt of annual reports and other non-financial benefits. Also, when shares are to be gifted to a third party, it is desirable to provide an easy and inexpensive means to convey to the third party at least some of the benefits associated with share ownership.

At present it is relatively difficult and costly to provide share certificates or other like financial instruments as a gift, particularly when only a few shares are in question. For the giver of a gift, the cost of obtaining a printed share certificate is relatively high. For the recipient of share certificates, selling any shares held in the form of share certificates is relatively complicated and cannot be effected on demand, as those shares cannot be sold or traded until the share certificates are endorsed, and the shares are registered by a broker in a book-base system, i.e. entered in a trading account for the recipient Also, there are regulatory hurdles which render it fairly difficult to make a gift of a financial instrument. It is also undesirable for a share issuing corporation to have on its books a large number of small shareholders, since each such shareholder is entitled by law to receive annual reports, as well as being issued proxy voting forms and the like. The cost of meeting these legal requirements is significant for any corporation; for a corporation having a large number of holders of a relatively few shares each, the cost becomes excessive.

Thus, it is desirable to provide a system which is easy to use for consumers who wish to get printed share certificates or wish to transfer printed share certificates to others as a gift or otherwise. For the individual donor, it is desirable to provide a simple and low cost means to gift a third party with a share certificate or other like financial instruments, and to give the third party a printed certificate along with certain financial participation rights. For the individual recipient of such share certificates, it is desirable to provide a simple means to redeem shares held in the form of share certificate, on demand and without any of the complications associated with selling shares that are held as original share certificates issued by the share issuing corporation. Such a system should be rapid, while at the same time being easy for the donor to acquire share certificates with minimum transaction costs; for the recipient to redeem shares held in the form of share certificates, on demand and with minimum trouble; and with a minimum of trouble and expense for the broker and share issuing corporation.

An approach to realize the above, which is now proposed by the inventor, is to provide printed certificates which may be issued by a broker, and which take the place of the original stock certificates of corporations or other original financial instruments. Such certificates represent a security or other financial instrument, with ownership of the underlying instrument remaining with the broker. Any such certificate is thus issued by the broker rather than the share issuing corporation and represents a contract between the broker and the holder of the certificate. From the holder's perspective, such certificate emulates the original share certificate and provides certain financial benefits without the accompanying drawbacks as discussed above.

It has been previously proposed to provide a system for transfer of share certificates not directly originating from a share issuing corporation. For example, U.S. Pat. No. 5,926,552 (McKeon) discloses a process for transferring stock certificates by way of transferring certain information electronically. In particular, a stockholder's signature is authenticated by transferring certain information electronically. This then permits a transfer agent to carry out a transfer of stock certificates. While the certificate legally originates from the share issuing company, there is no direct transfer from the company to the ultimate recipient. However, this requires a purchaser to physically meet with an agent, who handles and prepares various documents. As well, the step is still required whereby the share certificates must be separately issued by the share issuing corporation.

Also, the share certificates must still be individually recorded with the share issuing corporation making their transfer to a third party difficult and also representing an ongoing expense to the share issuing corporation to maintain the stockholder in its records.

There is thus a need for a system whereby a person may purchase and quickly receive certificates representing any number of shares or other financial instruments, to enable him to transfer the physical certificate to a third party by way of a gift or otherwise, with a minimum of transaction costs and paperwork. There is also a need for a system whereby a person who owns any such certificate can redeem the certificate easily at the market value of the underlying shares at the time of redemption.

### OBJECTS OF THE INVENTION

It is an object of the present invention to provide an improved system for transferring certificates representative of shares and other like financial instruments, whereby any such certificate may be purchased by a first party from a broker, agent or supplier, and transferred to a third party, with the printed certificate being accompanied by at least some of the accompanying shareholder rights. The certificates and their underlying rights are transferable to a third party. At least one of the rights provided by such certificate is the right to participate in any increase in the market value of the underlying corporate equity or other instrument. Another object of the present invention is to provide a system that allows the third party to sell or redeem certificates representative of shares and other like financial instruments. Another object of the present invention is to provide a system which provides certificates representative of publicly traded company shares, bonds, precious metals, commodities, futures, and any other publicly-traded properties, rights or articles.

### SUMMARY OF THE INVENTION

In one aspect, the invention comprises a system for issuing, transferring, and redeeming certificates representative of underlying publicly-traded property. The term “property” herein means any tangible or intangible property which is traded in a public financial market, such as company equity, bonds, commodities, futures, and foreign currency. In this aspect of the invention, the system comprises a series of steps involving a customer who makes a purchase, a supplier who supplies certificates and redeems such certificates on request, and a recipient, who may comprise the customer, who is the ultimate recipient and holder of the certificates. In general terms, the system consists of a computer programmed to permit or carry out the following steps:

1. A customer communicates with a supplier by any one of several means, such as logging onto an Internet website maintained by the supplier, thus establishing a primary customer-supplier link. This in turn triggers the opening of a link with a provider of securities information and trades, referred to herein as the “secondary link”. The secondary link may be between the supplier and a stock exchange or alternatively a brokerage firm. The secondary link must be capable of providing price quotes for selected property either in real time or with a minimal delay. The links are preferably established between computers but may also comprise other forms of telecommunication.

2. The supplier presents a menu to a customer listing a selection of available shares or other publicly-traded properties. For example, the menu may comprise a list of popular publicly-traded shares, selected commodities, futures contracts, bonds, or the like. The menu may optionally include a link to a brokerage service provider for a listing of additional equities or other instruments. The customer selects the particular equity or other property and the number of shares or other units he wishes to purchase.

3. On the customer's computer screen, the most recent available traded price of the property is displayed as well as optionally such information as share bid/ask prices, high/low prices for the day and the like. The information is provided by way of the secondary link.

4. The total price of the selected shares or other property is displayed to the customer. Optionally, the service charges may also be displayed at this time.

5. The customer is then prompted to provide personal information such as his home address, Email address, etc. As well, the customer is prompted to provide the name that he wants to appear on the certificate, if this is other than his own name, as well as the address where the certificate is to be delivered, and finally the appropriate billing information such as credit or debit card information.

6. Optionally, the customer may be prompted to select a mode of delivery or optionally, only a standard delivery mode is provided. Where several modes of delivery are available, selection of a mode of delivery will automatically display the cost associated with the delivery.

7. The information provided by the customer is entered automatically into a database maintained by the supplier.

8. Optionally, the customer may be prompted to verify the information that he has provided and to confirm the purchase. A final update of the purchase price may be provided, showing the total cost to the customer of the purchase. A confirmation message may be provided either immediately, or via Email following the carrying out of the customer's order, or both.

9. Preferably, the supplier's computer generates a unique certificate serial number, which will be printed on the customer's certificate. The serial number is entered automatically into the appropriate databases to identify the certificate that will be issued. The certificate is issued by the supplier and not by the share issuing corporation. The certificate represents underlying shares or other property, and includes the right to redeem the certificates for their current market value. Optionally the certificate would also carry the right to receive a dollar amount equal to any dividends declared by the share issuing corporation, or any other financial rights associated with the property.

10. The supplier's computer supplies the necessary information to a printing means, which prints the appropriate certificate which is then packaged and shipped to the appropriate recipient. An Email message may be sent to the customer to confirm shipping.

The customer's purchase optionally triggers a request from the supplier, for the supplier to purchase via the secondary link securities in the same or a similar number as on the certificate. Any such purchase is subsequently recorded in the supplier's database to track the supplier's portfolio of stocks and other property. Alternatively, the supplier's computer may trigger a request to purchase securities independently from each issued certificate. E.g., the request to buy securities in the name of the supplier may be triggered when shares of a certain stock corresponding to issued certificates exceeds the number of share in the supplier's stock portfolio by a predetermined number. However, if property is purchased by the supplier in support of the certificates, ownership of such property remains in the hands of the supplier, with the supplier becoming the registered owner of the property. In the case of company stock the supplier is recorded on the books of the share issuing corporation as the owner.

The customer is provided with a certificate issued directly and solely by the supplier, entitling the customer to redemption of the certificate by the supplier for the trading value of the underlying property. Thus, the share issuing corporation (in the case of equities) need not maintain the name of the customer on its books at considerable savings to the share issuing corporation.

The primary and secondary links are contemplated herein as comprising Internet-based communications. However, other telecommunications links may be employed for one or both of the links such as non-internet computer links or telephone links.

The expression “publicly-traded property” used herein means a financial instrument traded on a public exchange for such instruments and representative of an underlying property. Examples, not intended to be limiting, include shares in publicly-traded companies, bonds, commodities, options and other futures.

### BRIEF DESCRIPTION OF THE DRAWING

FIG. 1 is a block diagram flow chart, showing operation of the system according to the present invention.

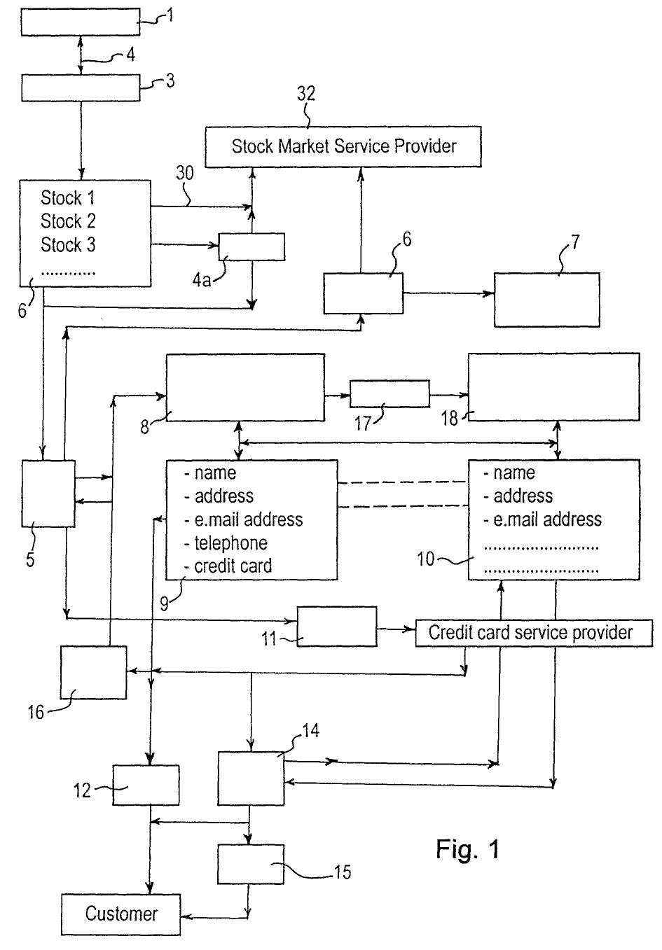

### DETAILED DESCRIPTION OF THE PREFERRED EMBODIMENTS

In one embodiment described herein, the system is operated via communication links established over the Internet. However, it will be seen that with minimum modification the system may be designed to operate over other modes of communication, e.g. via a direct computer-computer telephone connection or via commands issued by a telephone keypad or in person.

The system comprises a computer which is linked to several telephone lines, and programmed to provide data processing and storage nodes and tables, interactive communication means and other information and data manipulation means, as will be more fully described below.

Turning to the Figure, a supplier initially selects a group of publicly-traded properties that will be offered to customers as the subject of its certificates. It is contemplated that these will comprise a selection of popular “blue chip” stock and optionally commodities such as crude oil, gold, etc. The supplier may also select as an option, a basket of shares selected by the supplier or alternatively a popular basket such as the Dow Jones Industrial Average, the NASDAQ Index or the like. The various instruments selected by the supplier appear on a menu.

In the preferred embodiment as a first step, a customer accesses the supplier via a website to establish a first link 4. The customer enters keystrokes into the customer's computer 1. The customer's computer 1 has a modem, permitting the computer to transmit data over a telephone line to a recipient's computer. The customer has access to the Internet and the Worldwide Web, via an Internet Service Provider under contract to the customer to provide such services. In order to contact the supplier, the customer enters the URL of the supplier into his computer, which then establishes an Internet-based connection 4 between the customer and the supplier's computer 3, which is also linked to the Internet and Worldwide web via a computer system and incorporating a modem. The supplier's computer system is programmed with a programming language that permits information, data, text and graphics over the Internet to the customer's computer. The first step upon accessing of the supplier's computer by the customer, is the presentation of introductory material by the supplier, e.g. the supplier's home page. The customer is then presented with the supplier's menu 6.

The supplier's menu consists of a screen display which is transmitted over the Internet communications link to the customer and appears on the customer's computer screen. The display consists of text and optionally graphics, and identifies the various publicly-traded properties such as equities which the customer may select as the basis for the certificate which he will purchase.

If the customer elects to make a purchase, or to get the price of shares, a secondary link 30 is established between the supplier and a provider of securities and publicly-traded property information 32 such as a broker or on the stock exchange. The secondary link consists of a telecommunications linkage between the supplier's computer system, and the computer system of a broker, stock exchange or other like provider. The secondary link may comprise a secure Internet-based telecommunications link, established via a service provider. Alternatively, the secondary link may comprise a direct computer to computer linkage established over a telecommunications means between the two computers. In either case, both the supplier and the provider of information must have a modem linked to their computer, with the modems in turn being linked telepathically.

In the case of publicly-traded corporate equities, the current trading price, and optionally the bid-ask prices is obtained by the provider. For example, in the case of a stock exchange, this information is obtained electronically and is contained in the stock exchange central computer, being updated on a real-time basis. This information is maintained in a constantly-updated database of the provider. The secondary link 30 permits the supplier to transmit a query to the provider concerning a particular security. The provider then transmits the price information concerning that security or several securities, to the supplier.

The customer may select one or more options by clicking his computer cursor on the appropriate menu items. The customer may select one of the listed options, or may select an option giving access to additional securities. If the latter option is selected, this triggers a search query 4(a) for other stocks via the third party stock market service provider 32. The customer also indicates in response to a query, the number of shares of the stock which is to be purchased or alternatively the amount of the selected commodity. Alternatively, the customer may be prompted to enter the total dollar amount he wishes to spend with the supplier then providing a selection of stocks and the number of shares that may be purchased from each selected stock.

The number of shares selected is entered in a database table 5, along with the share type or types selected. Entry of the number of shares in the database table 5, consists of receiving the corresponding information from the customer via the first communications link, and storage of the information in a portion of computer memory selected for the purpose such as a part of the random access memory of the supplier's computer. The information in the database table 5 may as well be transmitted from the random access memory to a permanent information storage means such as the computer hard drive and/or a computer disk, CD ROM, or other like information storage means. In like fashion, all other data and information transmitted by the customer to the supplier is stored in random access memory or other temporary information storage mode within the supplier's computer, and preferably also stored in a more permanent memory storage means within the supplier's computer system.

The selection entered in table 5 also triggers a query 6 to the stock market service provider over the secondary link to obtain the most recent traded price, and the result and total price of the shares is then displayed in display 7. The properties contained within table 5 are entered into table 8, which lists all properties selected by the customer which must be subsequently or purchased by the supplier or recorded in the supplier's database as properties for which the supplier has issued certificates, but which are not yet included in the supplier's portfolio in support of issued certificates.

The customer is then requested to enter his personal information such as name, address, credit card payment information (or other payment information) and any other information that is desirable or may be required by any applicable legislation. This information is recorded in table 9 and stored in like fashion as described above.

The customer is then asked to enter the name and address of the ultimate recipient of the certificate and any other information that may be desirable or required by law. This information is routed to the appropriate data entry and storage means and is recorded in tables 10. It is contemplated that the customer may either choose to receive the certificate that he will then give to the ultimate recipient, or he may choose to have the certificate delivered directly to the ultimate recipient, in which case the customer may wish to provide a short message to the recipient, which is then recorded at this stage.

The customer may be prompted to enter another stock selection if he wishes to purchase another certificate, in which case at least some of the above steps are repeated.

The customer is then prompted to confirm his purchase, upon which the system prompts an update query to update the share price through table 5, calculates the total purchase price of the certificate based on the share price, and optionally a handling fee, and triggers at 11 a query to the credit service provider to validate the credit card payment for the total purchase price.

The query to the credit card service provider consists of establishing a telephone link between the service provider computer and the credit service provider computer via a modem and telephone linkage. Data is then transmitted from the supplier, consisting of the credit card number of the customer and the purchase amount. The credit service provider in turn transmits data to the supplier consisting of either approval or disapproval of the purchase amount. If a disapproval is obtained, the supplier transmits this information to the customer and the purchase will not be permitted to continue.

Once the credit card payment is validated by the credit card company, the system triggers at 12 a confirmation that the certificate has been purchased comprising a transmission of data over the first communication link to the customer. This confirmation is sent to the customer by Email. In the next step, credit card payment validation triggers at node 14 the generation of a serial number for the customer's certificate. This number is entered in Table 10 where the recipient data is collected.

Data relating to the certificate is then transmitted from the supplier's computer system, via a cable linkage to permit printing of the certificate. The relevant data will include at a minimum the name of the recipient, the type and number of shares or other properties and the name and other identifying information of the supplier. As well, the serial number is transmitted to the printing means.

A certificate is then printed by a printing means such as a laser printer 15 with the data consisting of the serial number, the recipient's name and optionally his address, and the number and types of securities represented by the certificate. The term “serial number” refers to any numeric, alphabetic, alpha-numeric, or other code which uniquely identifies the certificate. Alternatively, at the option of the customer, the customer is provided electronically with the data that enables him to print the certificate.

The credit card validation step 11 also triggers an update query 16 via the secondary link to update the data in data table 8 with up-to-date share price information from database table 5. The updated data from table 8 is then transmitted to node 17 which triggers purchase of the stocks in table 8 from the stock market service provider or alternatively from any other source. Purchase of stocks is effected by transmitting data to the service provider (or other source of properties), consisting of the supplier's name and other identifying information, the number and type of properties requested. The supplier will have established in advance an account with the service provider wherein share purchases are automatically charged to the account of the supplier.

The system may be set to automatically purchase an identical number of properties or alternatively a similar number for example, a “round up” or “round down” to a convenient number. Information on the stock thus purchased is then entered in table 18, which maintains a list of all securities and their quantities of securities, that have been purchased by the supplier in support of issued certificates.

Purchase of the underlying securities by the supplier is optional. The supplier may elect to purchase other financial instruments or otherwise invest the funds received from the customer.

If the certificate is printed by the supplier, the printed certificate is then appropriately packaged, for example, in an envelope and mailed or otherwise shipped to the customer or to the ultimate recipient, as requested by the customer, where mailing to the ultimate recipient may include any accompanying message desired by the customer.

The certificate may be redeemed at any time by the certificate holder for the current trading price of the underlying securities. The redemption of the certificate may be effected by one of several possible ways. The holder may simply mail the certificate back to the supplier and request redemption. The supplier then issues a cheque to the certificate holder for the current trading price of the securities as of the date the certificate is received. Optionally, the supplier may deduct a handling fee from the amount he pays.. Alternatively, for more immediate service, the holder may convey a message to the supplier, for example, by telephone or via Email, stating that the holder wishes to redeem the certificate. The certificate is then cancelled electronically, and the holder is issued a cheque in the appropriate amount, or optionally the funds are transferred electronically to the holder or the holder's bank account. The supplier would then send a notice of redemption and certificate cancellation to the holder, either via Email or mail.

It is contemplated that the supplier would maintain a portfolio of stocks and other property in his own name to enable him to redeem issued share certificates at their market value. Every issued certificate representing a number of shares would be recorded and identified in the supplier's database table 18 to enable the supplier to track the number of shares that he should add to his portfolio from time to time. The supplier's purchase of shares is triggered according to a built-in protocol where shares would be purchased for example on a daily basis, or when the number of any shares corresponding to issued certificates reaches a certain number, or other parameters. It is also contemplated that certificate redemption may trigger the supplier's computer to sell shares to recover certificate redemption costs, where share selling may be triggered according to built-in protocol. E.g., the supplier's computer may trigger a sale of certain securities where the securities maintained in the supplier's portfolio exceed by a predetermined amount the securities corresponding to all outstanding share certificates issued by the supplier and representing those securities.

Certificate holders may also be entitled to participate in dividends and stock splits, and other like benefits. In the case of dividends, receipt of a dividend in the account of the supplier triggers a notification to the certificate holder. The supplier, as the owner of record of the underlying securities, is notified of any such event. This information is either manually entered into the supplier's computer system or is automatically entered via a data entry sent by the brokerage service provider. In either case, the appropriate data is entered into the account information node relating to the particular certificate. The dollar value of the dividend is then placed in the account of the holder and at the option of the holder either remains in the holder's account, optionally in an interest bearing account, or optionally payment may be issued to the holder by a cheque. Similarly, any stock split or other event relating to the value or effective number of the shares of the share issuing corporation may automatically triggers a notification to the holder, for example by Email. Optionally, an additional or replacement certificate may then be printed by the supplier and mailed or otherwise conveyed to the holder. Other like events, such as options or warrants issued by the share issuing corporation, may be otherwise conveyed or notified to the holder.

In the figure, linkages are shown between various of the tables and nodes. Such linkages may provide data transmission to confirm within the database system that certain prescribed steps have been taken, or to relay purchase information between nodes and tables.

1. A system for issuing, transferring and redeeming certificates representative of underlying publicly-traded property, comprising:
(a) means for establishing a first communication link between a customer and a supplier;
(b) means for providing a menu to a customer, said menu containing a list of publicly-traded properties, and including a means for permitting said customer to select a quantity of one or more of said properties;
(c) means for establishing a second communication link between said supplier and a provider of price information in respect of said properties;
(d) means for communicating to said customer the market price of said selected properties, as well as the total price of said selected properties;
(e) means for receiving personal information from a customer, including payment information;
(f) means for receiving information in respect of share certificate recipient, including name and home and/or Email address of said recipient;
(g) means for storing in a database information with respect to said customer, said recipient and properties corresponding to said certificate; and
(h) means for conveying said certificate to said customer or to said recipient either in printed or in electronic form, to be printed by the customer or by the recipient.

2. A system as defined in claim 1, further comprising means for redeeming said certificate at the option of said customer or said recipient at a redemption value, said redemption value being the market value of said publicly-traded property or properties at the time and date of redemption, optionally minus a service charge.

3. A system as defined in claim 1, further comprising means for automatically generating a serial number to identify each issued certificate.

4. A system as defined in claim 1, further comprising means for automatically purchasing shares by the supplier, in response to issuing said certificate to said customer or recipient.

5. A system as defined in claim 1 wherein said property comprises a publicly-traded share of a share issuing corporation.

6. A system as defined in claim 1 wherein said first communication link is established via an Internet website.

7. A system as defined in claim 1, further comprising means for said supplier to maintain a data link with a stock market service provider, for the provision of current market prices for selected securities and for effecting purchasing and sale of shares or other publicly-traded property.

8. A system as defined in claim 1, further comprising means for adding a service charge to a customer order upon receipt of same for the purchase or redemption of said certificate.

9. A system as defined in claim 1, further comprising means for validating customer payment.

10. A system as defined in claim 4 further comprising means for purchasing of said publicly-traded property on the open market by said supplier in the same or similar quantity as represented by said certificate, in response to issue of said certificate to said customer or recipient.

11. A system as defined in claim 10, further comprising means for selling said publicly-traded property on the open market by said supplier in the same or similar quantity as represented by said certificate, in response to redemption of said certificate by said customer or recipient.

12. A system as defined in claim 1 comprising means to automatically notify said customer or recipient of events relating to the value or effective number of said publicly-traded properties which could require an adjustment to said certificate.
